(19) United States
(12) Patent Application Publication
(10) Pub. No.: US 2012/0060646 A1
(43) Pub. Date: Mar. 15, 2012

(54) BICYCLE PEDAL

(75) Inventor: Franc Arnold, Koblenz (DE)

(73) Assignee: RTI SPORTS/VERTRIEB VON SPORTARTIKELN GMBH, Urmitz (DE)

(21) Appl. No.: 13/049,990

(22) Filed: Mar. 17, 2011

(30) Foreign Application Priority Data
Mar. 18, 2010 (DE) 20 2010 003 827.8

(51) Int. Cl. B62M 3/08

(52) U.S. Cl. 74/594.4

(57) ABSTRACT

A bicycle pedal comprises a pedal body having a support surface and a pedal axle rotatably supporting the pedal body. The pedal is characterized in that the support surface has a recess extending substantially across the entire width of the pedal, the deepest portion of the recess being offset from the pedal axle.

### CROSS REFERENCE TO RELATED APPLICATIONS

The present invention claims the priority of German Utility Model Application no. DE 20 2010 003 827.8 filed on Mar. 18, 2010, the disclosures of which are incorporated herein by reference.

### BACKGROUND OF THE INVENTION

1. Field of the Invention

The invention refers to a bicycle pedal.

2. Description of the Prior Art

For a good and uniform transmission of force onto a bicycle pedal, the position of the foot relative to the pedal, in particular to the pedal axle, must be defined. With known bicycle pedals which are used in particular with sports bicycles, this is realized by so-called click pedals. Here, the sole of the shoe is provided with a catch element that cooperates with a catch element provided on the pedal body. The pedal system is disadvantageous in that special shoes have to be used. Further, due to the protruding catch element on the sole of the shoe, these shoes are not suitable for walking. It is another disadvantage of click pedals that in particular inexperienced users may not be able to disengage their foot from the pedal in time. This may cause a fall, e.g., when coming to a halt or in danger situations. Therefore, click-pedals have only prevailed in the field of sports. In particular for city bicycles, trekking bicycles or the like, click pedals are unsuitable.

Conventional pedals have the disadvantage that the position of the foot on the pedal is not defined. As a result, the transmission of force is compromised. Specifically, such false positions may cause significant loads on the joints. In particular when the heel is turned outward or inward, unfavourable loads occur in the knee joint, as well as in the hip joint.

Further, the foot is often put too far forward in the longitudinal direction of the pedal, i.e., in the direction of travel. As a result, the force transmission is not effected in the region of the ball of the foot or the joint of the big toe although the most effective force transmission could be achieved there.

### SUMMARY OF THE INVENTION

It is an object of the invention to provide a bicycle pedal in which the position of the foot relative to the pedal is improved also for a non-fixed connection of a shoe and the pedal.

The bicycle pedal of the present invention is configured such that no fixed connection is provided between the sole of a shoe and the pedal. Specifically, different from click pedals, no catch elements or the like are provided. The bicycle pedal has a pedal body preferably made from plastic material. The pedal body forms a support surface for the shoe. Usually, the pedal body has two opposite support surfaces so that the foot can be put on the pedal irrespective of the pedal's position. The pedal body is rotatably supported by a pedal axle, with the pedal axle usually being adapted to be threaded into a threaded bore of the crank.

According to the invention, the at least one support surface comprises a recess. The recess extends across the entire width of the pedal, i.e. from an inner side of the pedal body directed toward the crank to an opposite outer side of the pedal body. The recess may be formed e.g., in the manner of a depression or a groove with a large radius. Likewise, the recess can be wedge-shaped, for example, with inclined planes extending from a front side and a rear side of the support surface and thus forming the recess. According to the invention, the recess has a deepest portion. The same preferably extends across the entire width of the pedal. Thus, this deepest portion forms a sort of valley bottom or bottom of a depression. According to the invention, this deepest portion of the recess is arranged offset with respect to the pedal axle, i.e., with respect to a centre line of the pedal axle around which the pedal can rotate.

Such a recess, as provided according to the invention, has the effect that the foot of a cyclist is intuitively positioned better on the pedal. For one, there is no more pedaling using the metatarsus, since the sole of the foot or shoe no longer rests flatly on the pedal, but would touch the support surface of the pedal only at the front and rear sides. The user intuitively pulls the foot backward, since the shoe and the foot can be bent in the region of the toe joints so that the shoe again rests on the pedal, making full contact therewith. Thus, providing a recess, such as a depression, has the first advantage that the user positions his foot on the pedal such the transmission of force is effected substantially via the ball of the foot or the metatarso-phalengeal joints, respectively. Since, according to the invention, the deepest portion of the recess is offset with respect to the pedal axle, the foot is also intuitively placed on the pedal in a manner corresponding to the offset. This results in an ergonomically better position of the foot. By arranging the deepest portion of the recess in this manner, it is prevented that the heel of the foot is turned too far outward or inward. The ergonomically improved position of the foot on the pedal reduces the loads occurring in particular in the ankle joint and the knee joint, but also the loads occurring in the hip joint.

In a particularly preferred embodiment, the recess is formed such that a center line of the deepest portion includes an angle ≠0° with the pedal axle. In particular, the angular range is from 5-15° and, more preferred, from 5-10°. The center line preferably extends across the entire width of the pedal and runs substantially almost transversely to the traveling direction. In this case, the pedal axle or the center line of the pedal axle extends exactly transversely to the traveling direction. The center line of the deepest portion includes a corresponding angle with this line. It is preferred that the center line of the deepest portion is inclined with respect to the pedal axle in the direction opposite to the traveling direction. In a preferred embodiment, the intersection of the center line of the pedal axle and the center line of the deepest portion is located in the region of the inner side of the pedal body.

It is particularly preferred to design the recess such that it has no steps, but rather extends, in particular, in a continuous manner. This allows a smooth design of the support surface. In particular, the depth of the recess increases continuously, starting from a rear side of the support surface to the deepest portion of the recess. It is particularly preferred that the depth decreases, starting from the deepest portion of the recess to the front side of the support surface. To further improve the position of the foot and to prevent the user from placing his foot too far forward on the pedal, it is possible to make the inclination from the deepest portion of the recess to the front side of the support surface somewhat steeper or more pronounced than in the rear portion.

Preferably, the depth of the recess is substantially constant across the entire pedal width. If need be, the recess may be somewhat less pronounced in the outer portion of the support surface, so that the foot is slightly pressed or held inward. This guarantees that the foot is set on the pedal as close as possible to the crank.

Preferably, the pedal of the invention is a pedal with opposite support surfaces. It is preferred that they are of the same design so that the user does not have to take care on which of the two sides he sets the foot. However, it is also possible to provide a combined pedal which is designed as a click pedal on the one side and, on the other side, as a pedal of the inventive design with a recess. Such a pedal can thus, on the one hand, be used with special shoes, e.g. with a click connection, and, on the other hand, when conventional shoes are used, such a pedal also guarantees an ergonomically favorable position of the foot, as well as a good transmission of force, when the foot is placed on the support surface designed according to the invention.

In the deepest portion, the recess has a depth of 1-4 mm, preferably 2-3 mm, relative to the rear side of the support surface and/or the front side of the support surface.

The position of the foot can be improved further, by making the support surface slanted outward, i.e. away from the crank. With such a slight inclination, the effect of a so-called Varus wedge is achieved. This has positive effects on the position of the foot joint. The inclination at the support surface preferably is 1-3°, in particular about 1.5°, with respect to the horizontal surface.

### BRIEF DESCRIPTION OF THE DRAWINGS

A full and enabling disclosure of the present invention including the best mode thereof, enabling one of ordinary skill in the art to carry out the invention, is set forth in greater detail in the following description, including reference to the accompanying drawing in which

FIG. 1 is a schematic top plan view on the bicycle pedal of the invention,

FIG. 2 is a schematic top plan view of the bicycle pedal illustrated in FIG. 1, with a foot being indicated in addition,

FIG. 3 is a side elevational view of the pedal in the direction of the arrow III in FIG. 1,

FIG. 4 is a side elevational view of the pedal in the direction of the arrow IV in FIG. 1.

### DESCRIPTION OF PREFERRED EMBODIMENTS

The bicycle pedal comprises a pedal body 10. In the embodiment illustrated, the pedal body 10 is provided with two support surfaces 12, so that both the upper side and the lower side of the pedal body are identical. In the pedal body, a pedal axle 14 is arranged in a cylindrical cavity, about which axle the pedal body 10 rotates. The pedal axle 14 is arranged such that a center line 16 of the pedal axle 14 extends perpendicularly to a crank (not illustrated). The pedal is mounted in the crank by means of the cylindrical projection 18 of the pedal axle 14 that is provided with a thread.

The support surfaces 12 of the pedal body 10 have a recess 20, which recess 20 is formed in the present embodiment by a concave shape of the support surfaces 12. Thus, the pedal body 10 is shaped such that, starting from a front side 22 of the support surface 12, the surface is of a concave shape such that the depth of the recess increases towards the deepest portion 20. Starting from the deepest portion 20 towards the rear side 24, the depth of the recess decreases. Thus, the deepest portion forms a kind of depression. Since the concave shape of the support surface 12 is formed such that it is constant across the entire width of the pedal, i.e. from a pedal inner side 36 to a pedal outer side 38, the deepest portion 20 can be defined by a center line 26. According to the invention, the center line 26 forms an angle α with the center line 16 of the pedal axle. The angle α preferably is 5-10°. The center line 26 is inclined rearward with respect to the traveling direction.

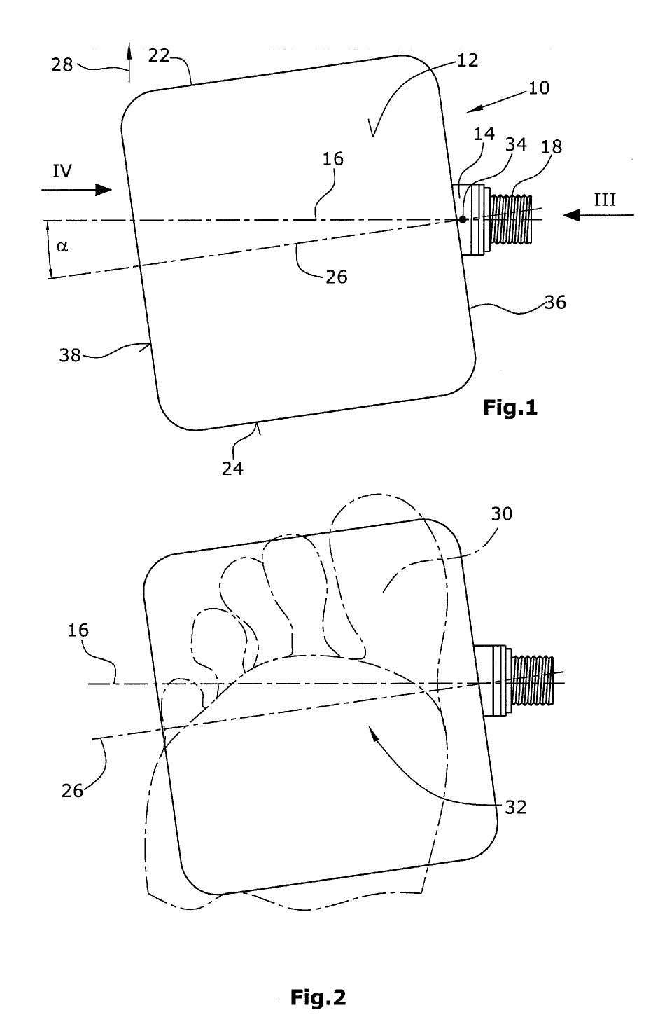

In the embodiment illustrated, the pedal body 10 is symmetrical in itself, so that the pedal body 10 is rotated from a conventional position, in which the two center lines 16, 26 would coincide, counterclockwise by the angle α in FIG. 1. The pedal body may of course also be of asymmetric design in order to offer a sufficient support surface in the region of the big toe 30, for instance.

By providing a recess 20 or a depression whose deepest portion 26 is offset or inclined with respect to the center line 16 of the pedal axle, the position of the foot is improved. Using the pedal of the invention, a cyclist will intuitively place his foot as illustrated in FIG. 2. On the one hand, the foot is thus positioned such that the transmission of force is not effected via the metatarsus, but via a ball-of-the-foot region 32. In other words: the transmission of force is effected, in particular with respect to the center line 26, via regions of the foot where the metatarso-phalengeal joints are located. In this region, the highest transmission of force is possible. Due to the inclination or the offset of the center line 26 with respect to the center line 16 of the pedal axle, an ergonomically favorable position of the foot is guaranteed. The user is less inclined to turn his heel too far outward or inward, which would specifically cause loads on the knee joints.

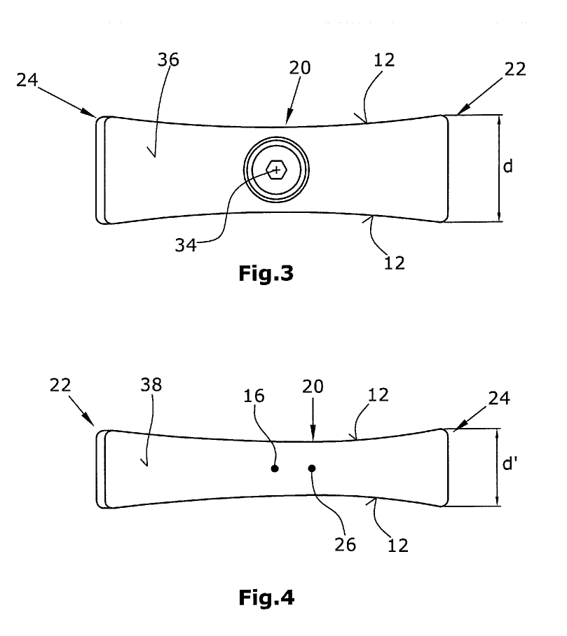

In the embodiment illustrated, the center line 16 of the pedal axle and the center line 26 intersect at a point of intersection 34 located in the region of the inner side 36 of the pedal body 10. Starting from the point of intersection 34, the distance between the two lines 16, 26 increases towards the outer side 38 of the pedal body 10, so that, at the outer side, they show the distance illustrated in FIG. 4. Here, the deepest portion 20 is always represented by the center line 26. A comparison of FIGS. 3 and 4 thus clearly shows that the deepest portion, starting from the inner side 36 to the outer side 38 of the pedal body 10, moves rearward, i.e. in a direction opposite to the traveling direction 28.

A further feature of the bicycle pedal illustrated in the Figures is that the thickness decreases, starting from the inner side 36 of the pedal body to the outer side 38 of the pedal body. In the region of the inner side 36, the pedal body 10 has a thickness d, and in the outer region of the outer side 38, it has a lesser thickness d′.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A bicycle pedal comprising
a pedal body having a support surface and
a pedal axle rotatably supporting the pedal body,
wherein
the support surface has a recess extending substantially across the entire width of the pedal, the deepest portion of the recess being offset from the pedal axle.

2. The bicycle pedal of claim 1, wherein a center line of the deepest portion includes an angle of preferably 5 to 15°, in particular 5 to 10°, with the pedal axle.

3. The bicycle pedal of claim 1, wherein the depth of the recess increases, in particular continuously, starting from a rear side of the support surface to the deepest portion, and preferably decreases, in particular continuously, starting from the deepest portion to a front side of the support surface.

4. The bicycle pedal of claim 1, wherein the depth of the recess is substantially constant across the width of the pedal.

5. The bicycle pedal of claim 1, wherein the recess is concave and preferably extends from the rear side of the support surface to the front side of the support surface.

6. The bicycle pedal of claim 1, wherein the bicycle pedal comprises two opposite support surfaces of identical design.

7. The bicycle pedal of claim 1, wherein the deepest portion has a depth of 1 to 4 mm, in particular 2 to 3 mm, with respect to the rear side and/or the front side of the support surface.

8. The bicycle pedal of claim 1, wherein the support surface of the pedal body is inclined, in particular continuously, downward from an inner side to an outer side, especially in the deepest portion of the recess.
